(19) United States
(12) Patent Application Publication
(10) Pub. No.: US 2011/0116613 A1
(43) Pub. Date: May 19, 2011

(54) AUTOMATIC NUMBER REFORMATTING

(75) Inventor: Eskil Gunnar ÅHLIN, Veberod (SE)

(73) Assignee: SONY ERICSSON MOBILE COMMUNICATIONS AB, Lund (SE)

(21) Appl. No.: 12/619,921

(22) Filed: Nov. 17, 2009

(51) Int. Cl. H04M 15/06

(52) U.S. Cl. 379/142.06

(57) ABSTRACT

A method of handling communications may include receiving a communication having a telephone number having a country/region code associated therewith. It may be determined whether at least a portion of the received telephone number matches a telephone number associated with an address book contact. The country/region code may be stored with the address book contact when at least a portion of the received telephone number matches the telephone number associated with the address book contact. A user request to transmit a communication to the address book contact may be received. The communication may be transmitted to the address book contact using the stored country/region code.

### BACKGROUND

Communication devices, such as cellular telephones, personal digital assistants (PDAs), messaging clients, gaming systems, laptop and desktop computers, etc. have become increasingly versatile. For example, cellular telephones often include applications that enable users to communicate with other mobile devices, via either voice calls or text messages. Such applications have made communication devices increasingly important to users.

In many instances, users of communication devices may move between various geographic locations. For example, a telephone user in Sweden may communicate with other users in Sweden, or may communicate with other telephone users in Sweden users from outside of Sweden.

### SUMMARY

According to one aspect, a method of handling communications, may include receiving a communication having a telephone number having a country/region code associated therewith; determining whether at least a portion of the received telephone number matches a telephone number associated with an address book contact; storing the country/region code with the address book contact when at least a portion of the received telephone number matches the telephone number associated with the address book contact; receiving a user request to transmit a communication to the address book contact; and transmitting the communication to the address book contact using the stored country/region code.

In another aspect, the received telephone number includes a international format telephone number that includes the country/region code, and the telephone number associated with the address book contact does not include the country/region code.

In another aspect, determining whether at least a portion of the received telephone number matches a telephone number associated with an address book contact may include determining whether a portion of the received telephone number that does not including the country/region code matches a telephone number associated with an address book contact.

In another aspect, the method may include storing the country/region with a recent calls listing when at least a portion of the received telephone number matches the telephone number associated with the address book contact.

In another aspect, the communication may include a telephone call request or a message.

In another aspect, storing the international format telephone number with the address book contact may further include storing the country/region code in a hidden entry corresponding to the address book contact.

In another aspect, transmitting the communication to the address book contact based on the stored international format telephone number may include displaying the telephone number associated with the address book contact.

In another aspect, the method may include determining whether a location of a calling device corresponds to a home location; and transmitting the communication to the address book contact using the stored country/region code when the determined location does not correspond to the home location.

In another aspect, determining whether a location of the device corresponds to a home location may include determining whether the device is roaming.

In another aspect, determining whether a location of the device corresponds to a home location may include identifying a network operator communicating with the device; determining a geographic location associated with the network operator; and determining whether the identified geographic location corresponds to the home location.

In another aspect, determining whether a location of the device corresponds to a home location may include identifying a geographic location associated with the device; and determining whether the identified geographic location corresponds to the home location.

In another aspect, a mobile terminal may include a receiver configured to receive a communication having an international format telephone number associated therewith; a memory for storing an address book for storing a number of contacts having telephone numbers associated therewith; logic configured to: determine whether at least a portion of the international format telephone number matches a telephone number associated with the address book contact; store and associate the international format telephone number with the address book contact when at least a portion of the international format telephone number matches the telephone number associated with the address book contact; and receive a user request to transmit a communication to the address book contact; and a transmitter configured to transmit the communication to the address book contact based on the stored international format telephone number.

In another aspect, the communication comprises a telephone call request or a message.

In another aspect, the international format telephone number includes a country or region code associated therewith, and the telephone number associated with an address book contact does not include the country or region code associated with the international format telephone number.

In another aspect, the logic may be further configured to: determine whether a geographic location of the mobile terminal corresponds to a home location associated with the mobile terminal, wherein the transmitter is configured to transmit the communication to the address book contact based on the stored international format telephone number when the geographic location of the mobile terminal does not correspond to the home location associated with the mobile terminal.

In another aspect, the logic configured to determine whether a geographic location of the mobile terminal corresponds to a home location associated with the mobile terminal, may be further configured to identify a network operator communicating with the mobile terminal; and determine whether the identified network operator is associated with the home location.

In another aspect, the logic configured to store the international format telephone number with the address book contact may be further configured to store the international format telephone number in a hidden entry corresponding to the address book contact.

In another aspect, a computer-readable medium having stored thereon a plurality of sequences of instructions which, when executed by at least one processor, cause the at least one processor to: receive a telephone call or message having an international format telephone number associated therewith; determine whether at least a portion of the international format telephone number matches a telephone number associated with an address book contact; store the international format telephone number with the address book contact when at least a portion of the international format telephone number matches the telephone number associated with the address book contact; receive a user request to transmit a communication to the address book contact; and transmit the communication to the address book contact based on the stored international format telephone.

In another aspect, the international format telephone number includes a country or region code associated therewith, and the telephone number associated with the address book contact does not include the country or region code associated with the international format telephone number.

In another aspect, the instructions cause the at least one processor to determine whether a geographic location associated with the computer-readable medium corresponds to a home location associated with the computer-readable medium; and transmit the communication to the address book contact based on the stored international format telephone number when the geographic location associated with the computer-readable medium does not correspond to the home location associated with the computer-readable medium.

### BRIEF DESCRIPTION OF THE DRAWINGS

Reference is made to the attached drawings, wherein elements having the same reference number designation may represent like elements throughout.

FIG. 1 illustrates concepts described herein;

FIG. 2 is a diagram of an exemplary system in which one or more embodiments may be implemented;

FIG. 3 is a diagram of an exemplary communication device of FIG. 2 according to an implementation;

FIG. 4 is a block diagram of exemplary functional components implemented in the communication device of FIG. 2; and

FIGS. 5 and 6 are flow diagrams illustrating exemplary processing by communication devices consistent with embodiments described herein.

### DETAILED DESCRIPTION

The following detailed description refers to the accompanying drawings. The same reference numbers in different drawings may identify the same or similar elements.

Systems and methods described herein may enable a communication device to automatically adapt to changing geographic dialing or calling requirements when, for example, calling or messaging address book contacts. In one exemplary implementation, international format telephone numbers may be captured and stored on the communication device during received calls or messages. The stored numbers may be associated with matching address book contacts. The stored international format telephone numbers may be used during subsequent calls to the respective contacts, without regard for the geographic location of the communication device.

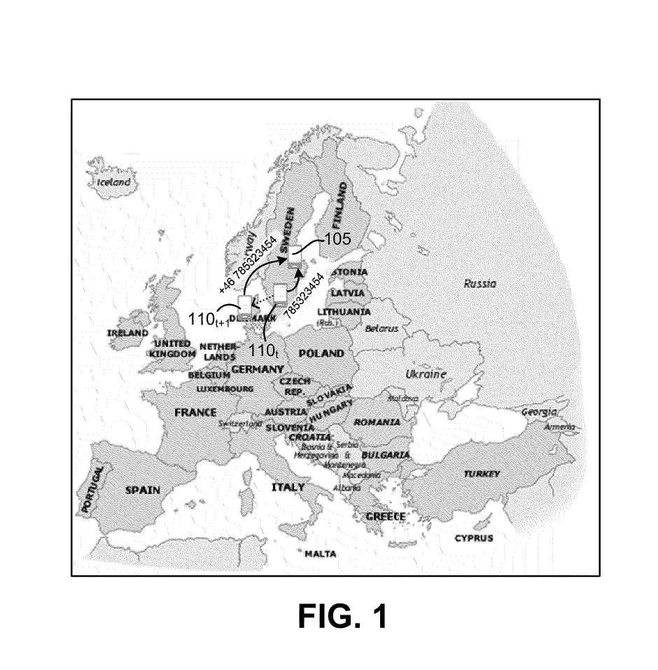

FIG. 1 illustrates the concepts described herein. FIG. 1 depicts a map of continental Europe and includes graphical representations of a first communication device 105 and a second communication device 110. Second communication device 110 is illustrated at two moments in time, as designated by the subscripts t and t+1. Each of devices 105 and 110 may have identification numbers, such as telephone numbers or subscriber numbers. For simplicity, a device's identification numbers is referred to herein as the device's “telephone number.” Depending on the country or region associated with the devices, the number may be a ten or eleven digit number and may include elements representative of geographical or political areas, such as an area or city code, etc., within the overall region or country.

In most instances, telephone numbers associated or assigned to devices also associated with a particular geographic or political region, such as a country, state, province, etc. This geographic or political region may be referred to as a device's home country or region. Typically, calls or communications (e.g., text messages) within a given country or other region that are made between devices associated with the same home country or region (i.e., intra-country) may be initiated based on the assigned number alone. For example, a call placed from one Swedish telephone to another Swedish telephone may be made by dialing a respective telephone number without including a corresponding country or region code or identifier, such as +46 in the case of Sweden.

Because of the relative frequency with which calls are placed between devices sharing a same home country or region, device users may store the number associated with such devices in a format that includes only the assigned telephone number and does not include the associated country code. For example, the telephone number for device 105 may be stored in an address book of device 110 as “0785 32 34 54,” without the corresponding “+46.” The interaction of device 110ₜ contacting device 105 with this telephone number (without the country or region code) is illustrated in FIG. 1.

Unlike intra-country calls or messages, calls or messages placed to a device (e.g., device 105) from outside of the country or region may not be completed by using the assigned number alone. Rather, the corresponding country or region code associated may have to be prepended to the assigned number prior to placing the call. This code notifies the other country's telecommunications service that the number dialed is located in or is otherwise associated with the country associated with the submitted country or region code. For example, a prepended +46 notifies calls originating from another country that the telephone number following the +46 is located or associated with Sweden.

Problems arise when telephones or other communication devices, such as device 110 in FIG. 1 are moved from a home country or region to another country or region. Because address book entries stored on device 110 have been stored in an intra-country format (i.e., without the corresponding country or region code), attempts to communicate with these contacts may result in errors or erroneous connections. To successfully communicate with address book contacts, it may be necessary for the user to manually insert the corresponding country code into the stored telephone number prior to initiating a call or message. The interaction of device 110ₜ₊₁ contacting device 105 with this telephone number and the corresponding country or region code is illustrated in FIG. 1. This is both cumbersome and aggravating and, in some circumstances, a user may not be aware of the appropriate country or region code to add.

Consistent with implementations described herein, a mobile device may automatically update or supplement an address book entry to include a corresponding country or region code. Subsequent attempts to communicate with the device associated with the entry, such as from an out-of-country or out-of-region location may be automatically made using the country or region code. By providing a mechanism for seamlessly and transparently updating address book contact numbers to enable easy dialing or communication when out of the user's home country, system's described herein may improve the ease of use of the mobile device.

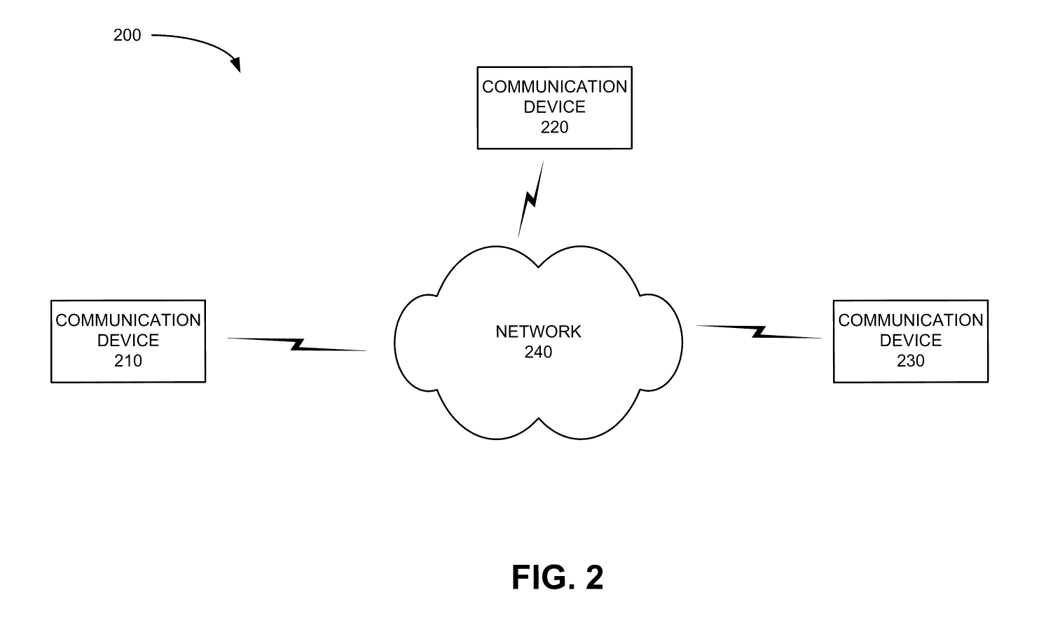

FIG. 2 is a diagram of an exemplary system 200 in which methods and systems consistent with one or more embodiments may be implemented. System 200 may include communication devices 210, 220 and 230 connected via network 240. The exemplary configuration illustrated in FIG. 2 is provided for simplicity. A typical system may include more or fewer devices than illustrated in FIG. 2. In addition, other devices that facilitate communications between the various entities illustrated in FIG. 2 may also be included in system 200.

Communication devices 210-230 may each include any type of device that is able to communicate via a network. For example, communication devices 210-230 may include any type of device that is capable of transmitting and receiving data (e.g., voice, text, images, multi-media data) to/from network 240. In an exemplary implementation, one or more of communication devices 210-230 may include a mobile terminal. As used herein, the term “mobile terminal” may include a cellular radiotelephone with or without a multi-line display; a smartphone device that may combine a cellular radiotelephone with data processing and data communications capabilities; a personal digital assistant (PDA) that can include a radiotelephone, pager, Internet/Intranet access, Web browser, organizer, calendar and/or a global positioning system (GPS) receiver; a thin client computer device configured to perform as an interface to another device over a computer network; and a conventional laptop and/or palmtop receiver or other appliance that includes a radiotelephone transceiver.

In an alternative implementation, one or more of communication devices 210-230 may include any client device, such as a personal computer (PC), a laptop computer, a PDA, a web-based appliance, etc., that is able to transmit and receive data via network 240. Communication devices 210, 220 and 230 may communicate with each other over network 240 via wired, wireless, or optical connections.

Network 240 may include one or more networks including a cellular network, a satellite network, the Internet, a telephone network, such as the Public Switched Telephone Network (PSTN), a metropolitan area network (MAN), a wide area network (WAN), a local area network (LAN), a mesh network, or another type of network. In an exemplary implementation, network 240 includes a cellular network or a combination of cellular and PSTN networks that use components for transmitting data to and from communication devices 210, 220 and 230. Such components may include base station antennas (not shown) that transmit and receive data from communication devices within their vicinity. Such components may also include base stations (not shown) that connect to the base station antennas and communicate with other devices, such as switches and routers (not shown).

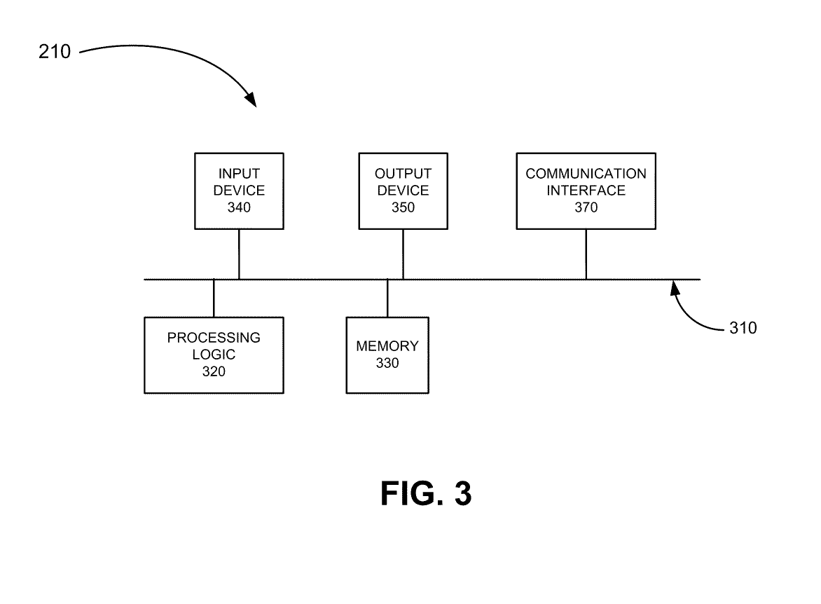

FIG. 3 is a diagram of communication device 210 according to an exemplary implementation consistent with one or more embodiments. Communication devices 220 and 230 may include the same or similar elements and may be configured in the same or a similar manner. Communication device 210 may include bus 310, processing logic 320, memory 330, input device 340, output device 350, and communication interface 370. Bus 310 permits communication among the components of communication device 210. Communication device 210 may be configured in a number of other ways and may include other or different elements. For example, communication device 210 may include one or more power supplies (not shown). Communication device 210 may also include a modulator, a demodulator, an encoder, a decoder, etc., for processing data.

Processing logic 320 may include a processor, microprocessor, an application specific integrated circuit (ASIC), field programmable gate array (FPGA) or the like. Processing logic 320 may execute software instructions/programs or data structures to control operation of communication device 210.

Memory 330 may include a random access memory (RAM) or another type of dynamic storage device that stores information and instructions for execution by processing logic 320; a read only memory (ROM) or another type of static storage device that stores static information and instructions for use by processing logic 320; a flash memory (e.g., an electrically erasable programmable read only memory (EEPROM)) device for storing information and instructions; and/or some other type of magnetic or optical recording medium and its corresponding drive. Memory 330 may also be used to store temporary variables or other intermediate information during execution of instructions by processing logic 320. Instructions used by processing logic 320 may also, or alternatively, be stored in another type of computer-readable medium accessible by processing logic 320

Input device 340 may include any mechanism that permits an operator to input information to communication device 210, such as a keypad, a microphone, a keyboard, a mouse, a pen, voice recognition mechanisms, a visual gesture interpreting engine (incorporating, for example, a gyroscope, an accelerometer, etc), a global positioning satellite (GPS) receiver, etc. Input device 340 may also include one or more buttons that allow a user to receive a menu of options via output device 350. The menu may allow the user to select various functions or modes associated with applications executed by processing logic 320.

Output device 350 may include one or more mechanisms that output information to the user, including a display, a printer, one or more speakers, etc. Output device 350 may also include a vibrator that causes communication device 210 to vibrate.

Communication interface 370 may include a transceiver that enables communication device 210 to communicate with other devices and/or systems. For example, communication interface 370 may include a modem or an Ethernet interface to a LAN. Alternatively, communication interface 370 may include other mechanisms for communicating via a network, such as a wireless network. For example, communication interface 370 may include one or more radio frequency (RF) transmitters, receivers, and/or transceivers for communicating via a wireless or cellular network 240.

Communication device 210, consistent with aspects described herein, may perform processing associated with receiving a telephone call request or text or multi-media message from one or more of communication devices 220 or 230 (or any other suitable communication devices) and automatically storing or identifying a country or region code associated with the calling device. Details relating to this processing are described below. Communication device 210 may perform these operations in response to processing logic 320 executing sequences of instructions contained in a computer-readable medium, such as memory 330. Such instructions may be read into memory 330 from another computer-readable medium via, for example, communication interface 370. A computer-readable medium may include one or more memory devices. In alternative embodiments, hard-wired circuitry may be used in place of or in combination with software instructions to implement processes consistent with embodiments described herein. Thus, implementations consistent with embodiments described herein are not limited to any specific combination of hardware circuitry and software.

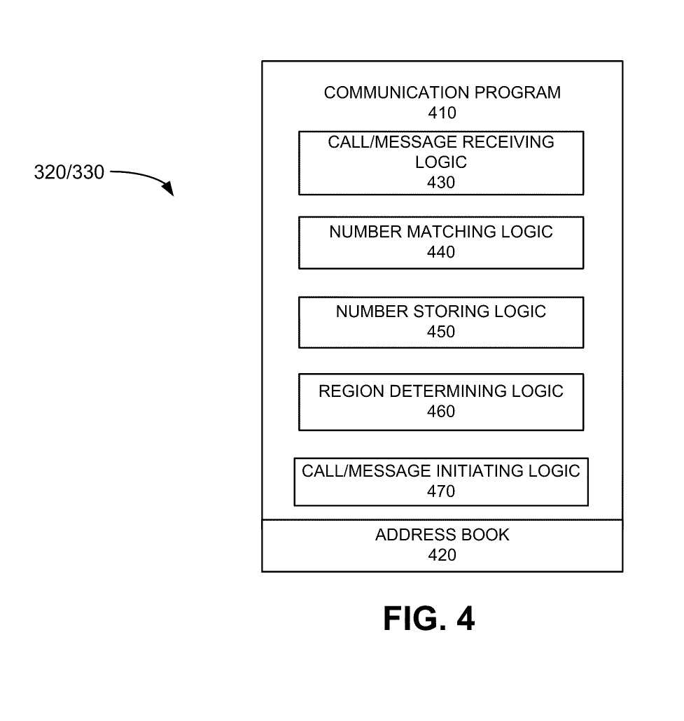

FIG. 4 is one implementation of an exemplary functional block diagram of components implemented in communication device 210 of FIG. 2, such as in processing logic 320 and/or memory 330. Referring to FIG. 4, memory 330 may include a communication program 410 and an address book application 420. Communication program 410 may include call/message receiving logic 430, number matching logic 440, number storing logic 450, region determining logic 460, and call/message initiating logic 470.

Communication program 410 may include any type of telephone or messaging program used to transmit and receive calls or messages to/from other devices, such as communication devices 220 and 230. For example, communication program 410 may include a voice call program, a short message service (SMS) program, a multimedia message service (MMS) program, an instant messaging (IM) program, or another application program that allows communication device 210 to communicate with other devices based on a telephone number or other regionally assigned identifier. Additionally, communication program 410 may include a video calling or video messaging application configured to transmit/receive audio and video data to/from another communication device.

Address book 420 may be used to store contact information for a number of contacts associated with other user devices. Typical information may include a name, a telephone number (or other contact identifier), a picture, an assigned ring tone, etc. As will be described more completely below, contact entries in address book 420 may also include one or more hidden attributes that include preference information, etc. relating to the contract.

Call/message receiving logic 430 may include hardware and/or software components for receiving telephone calls or messages, such as SMS or MMS messages delivered, based on a receiving device's telephone number. Although calls or messages may be received via various network types in network 240, consistent with one embodiment described herein, the calls and messages are routed to communication device 210 based on the telephone number associated with the device. In another embodiment, calls or messages are routed based on identifiers other than telephone numbers.

Number matching logic 440 may include hardware and/or software components for comparing telephone number information associated with an incoming call or message (e.g., a call or message's calling number identification (CNID), automatic number identification (ANI), or calling line identifier (CLI)) to telephone number information stored in address book 420. Received calls and messages may be associated with telephone number information that includes the region or country code associated with the calling device or party. For example, a call from Swedish subscriber number “0785 32 34 54,” may be received by user device 210 as “+46 785 32 34 54.”

As described above, users may store many telephone numbers in address book 420 in a format that does not include the country or region code. To accommodate this practice, number matching logic 440 may remove the country code from the received telephone number information (the “+46” in the above example) and may perform a lookup in address book 420 based on the remaining telephone number information (“785 32 34 54” in the above example). Matching number may be identified as a known contact to the user. For example, a name or image associated with the contact may be displayed to the user upon receipt of the call or message.

Consistent with implementations described herein, number storing logic 450 may include hardware and/or software components for storing the received telephone number including the country or region code or identifier (e.g., an “international format” telephone number) and associating the stored international format telephone number with a matching contact. In some implementations, this may include replacing the existing telephone number for the contact with the international format telephone number, such that all subsequent communications to the contact may be initiated using the international format telephone number. In other implementations, associating the stored number with the matching contact may include storing the received country or region code in another data field associated with the matching contact. This other data field may be invisible to the user during normal device operation, so as not to create undue confusion.

In some implementations, international format numbers for non-matching numbers may also be stored for subsequent use in the manner described below. For example, a listing or database associated with recent call history information may be updated to include a field having the international format telephone number.

Region determining logic 460 may include hardware and/or software components for determining a geographic location associated with communication device 210. In one implementation, region determining logic 460 may determine the geographic location of device 210 by identifying a geographic location of a network operator or service provider to which device 210 is connected. Identification information regarding the identity of a network operator or service provider may be provided in signals received from transmission facilities (e.g., cell towers, etc.) associated with the network operator. For example, region determining logic 460 may determine that the network operator providing service to device 210 is Orange Communications SA.

Region determining logic 460 may maintain or otherwise access (e.g., via network 240) a listing of regions or countries and their respective network operators or service providers. Region determining logic 460 may compare the identified network operator information (e.g., Orange Communications SA, in this example) and may determine the region or country associated with the identified network operator (Switzerland, in this case). Region determining logic 460 may determine whether the determined region or country is different than a home country or region associated with communication device 210.

In another implementation consistent with implementations described herein, region determining logic 460 may determine whether the region in which device 210 is currently located is different than a home region or country associated with device 210. For example, using signaling exchanged with network 240, region determining logic 460 may determine whether device 210 is within its home network. In other implementations, region determining logic 460 may maintain or otherwise access (e.g., via network 240) a listing of network operators or service providers associated with device 210's home region or country. Region determining logic 460 may determine whether the identified network operator is in the listing of network operators or service providers associated with the device 210's home region or country or whether device 210 is “roaming” outside of its home region or country.

In still another implementation, region determining logic 460 may determine whether the current region associated with device 210 is different than a home region or country associated with device 210 based on geographic location information associated with device 210. For example, a global positioning satellite (GPS) system may be used to determine a geographic location of communication device 210. The determined GPS location may be compared to geographic information associated with the home country or region.

In some implementations, region determining logic 460 may determine whether the region associated with device 210 is different than a region or country associated with an address book entry by comparing the determined region to a country or region code associated with the address book entry.

Call/message sending logic 470 may include hardware and/or software components for transmitting a call request or message to a contact stored with address book 420. Consistent with implementations described herein, when region determining logic 460 determines that communication device 210 is outside of its home country or region (or that the current region associated with device 210 is different from a country or region code associated with the contact), call/message initiating logic 470 may transmit the call request or message using on the stored international format telephone number.

Conversely, when region determining logic 460 determines that communication device 210 is within its home country or region (or that the current region associated with device 210 is the same as the country or region code associated with the contact), call/message initiating logic 470 may transmit the call request or message based on the user-entered telephone number associated with the contact.

In other implementations, call/message initiating logic 470 may transmit all call requests or messages using the stored international format telephone number. In some instances, when using the international format telephone number, call/message initiating logic 470 may be configured to display the user-entered telephone number associated with the contact.

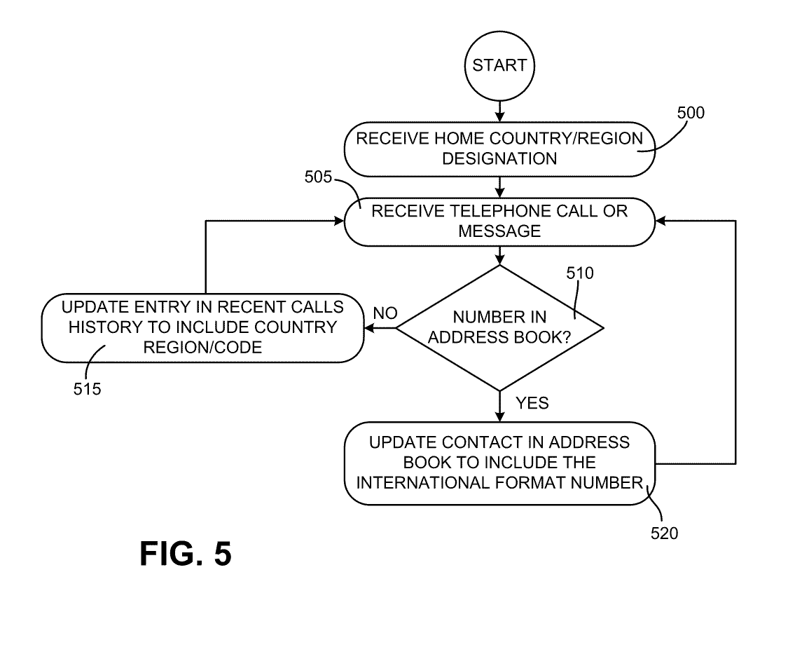

FIG. 5 is a flow diagram illustrating exemplary processing by communication devices, such as communication device 210, for handling address book-based calls or messages in the manner described herein. Processing may begin with communication device 210 determining and/or receiving and storing an indication of a home country or region associated with device 210 (block 500). In some implementations, designation of a home country or region may require an affirmative action on the part of a user. However, in other implementations, designation of a home country or region may be automatically determined based on the subscriber number, service provider, and/or service address associated with the device.

Communication device 210 may receive a telephone call or message (block 505). For example, as described above, call/message receiving logic 430 may interact with network 240 to receive a call request or message. The received call request or message may include telephone number information that includes the country or region code associated with the calling device (e.g., communication device 220). Exemplary calling party telephone number information may be included in CNID, ANI, or CLI information associated with the received call request or message.

Communication device 210 may determine whether the telephone number information corresponds to a contact in address book 420 (block 510). For example, number matching logic 440 may determine whether the telephone number information associated with the received call request or message, either in its entirety, or following removal of a country or region code from the number, matches any user-stored telephone number information included in address book 420.

If a match is not made (block 510-NO), an entry in a recent calls database or listing may be updated to include the international format telephone number, e.g., the telephone number that includes the country or region code (block 515). In a manner similar to that described below for address book contacts, a user of device 210 may initiate a call or message to a number in the recent calls database or listing. Processing may return to block 505 for a next received telephone call or message.

If a match is made (block 510-YES), information associated with the identified contact may be updated to include the international format telephone number (block 520). For example, as described above, number storing logic 450 may store the international format telephone number into an entry associated with the matching contact. In another implementation, number storing logic 450 may store the country or region code associated with the telephone number of the matching contact. The international format telephone number may be hidden or invisible to the user in some implementations, to avoid confusion, or the appearance of redundancy.

Processing may return to block 505 for a next received telephone call request or message. In this manner, international format information for telephone numbers corresponding to received calls or messages may be automatically collected by communication device 210, with little or no impact to the user. As will be described below, the stored international format telephone number information may be used to transmit call requests or messages from communication device 210 to corresponding contacts, when communication device 210 is located outside of the designated home geographic region or country.

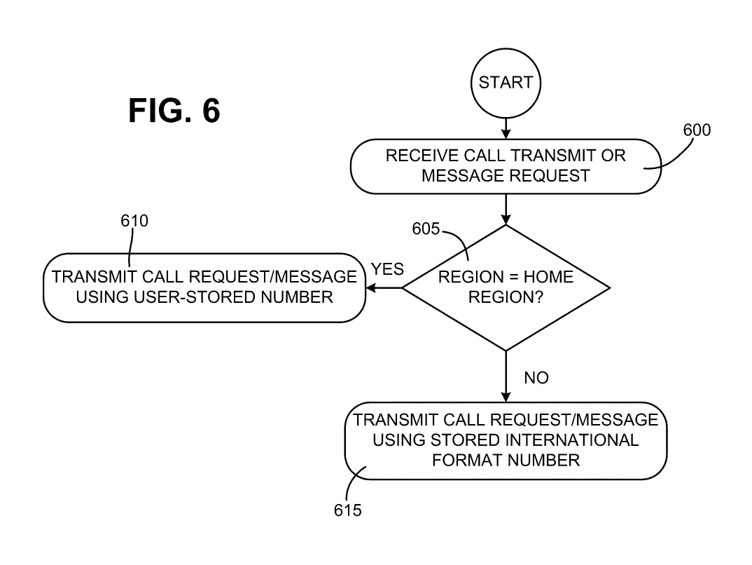

FIG. 6 is a flow diagram illustrating exemplary processing by communication devices, such as communication device 210, for initiating address book-based calls or messages in the manner described herein. Processing may begin with communication device 210 receiving a request to transmit a call request or message to a contact in address book 420 (block 600). For example, call/message sending logic 470 may receive a user request to initiate a telephone call to a contact, or transmit a message (e.g., an SMS or MMS message) to the contact.

Region determining logic 460 may determine whether communication device 210 is located inside of communication device 210's home country or geographic region (block 605). For example, as described above, region determining logic 460 may identify and compare a current network operator with which device 210 is connected to a list of known network operators. Region determining logic 460 may determine the location of the identified network operator. For example, region determining logic 460 may determine that the identified network operator is not associated with the home country or region designated in block 500 above. Alternatively, region determining logic 460 may identify a country or region associated with the identified network operator and may compare the identified country or region to the device's home country.

When it is determined that communication device 210 is located inside of communication device 210's home country or geographic region (block 605-YES), call/message sending logic 470 may transmit the call request or message using the user-stored telephone number information (block 610). However, when it is determined that communication device 210 is not located inside of communication device 210's home country or geographic region (block 605-NO), call/message sending logic 470 may transmit the call request or message using the stored international format telephone number (bock 615). In some implementations, the use of the international format telephone number may be made transparent to the user, so as to avoid confusion on the part of the user.

By providing an efficient and substantially automatic manner for adapting to potentially changing geographic dialing or calling requirements, systems and methods described herein may improve the ease with which calls are made or messages are sent to address book contacts when a user is traveling abroad. More specifically, by capturing international format telephone numbers during received calls or messages and storing the received international format telephone numbers in the address book entries, subsequent calls to the respective contacts may be easily made without the user being concerned about the geographic location of the respective communication devices.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to the exemplary processes illustrated in FIGS. 5 and 6, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method of handling communications, comprising:
receiving a communication having a telephone number having a country/region code associated therewith;
determining whether at least a portion of the received telephone number matches a telephone number associated with an address book contact;
storing the country/region code with the address book contact when at least a portion of the received telephone number matches the telephone number associated with the address book contact;
receiving a user request to transmit a communication to the address book contact; and
transmitting the communication to the address book contact using the stored country/region code.

2. The method of claim 1,
wherein the received telephone number includes a international format telephone number that includes the country/region code, and
wherein the telephone number associated with the address book contact does not include the country/region code.

3. The method of claim 2, wherein determining whether at least a portion of the received telephone number matches a telephone number associated with an address book contact comprises:
determining whether a portion of the received telephone number that does not including the country/region code matches a telephone number associated with an address book contact.

4. The method of claim 1, further comprising:
storing the country/region with a recent calls listing when at least a portion of the received telephone number matches the telephone number associated with the address book contact.

5. The method of claim 1, wherein the communication comprises a telephone call request or a message.

6. The method of claim 1, wherein storing the country/region code with the address book contact comprises:
storing the country/region code in a hidden entry corresponding to the address book contact.

7. The method of claim 6, wherein transmitting the communication to the address book contact based on the stored international format telephone number comprises:
displaying the telephone number associated with the address book contact.

8. The method of claim 1, further comprising:
determining whether a location of a calling device corresponds to a home location; and
transmitting the communication to the address book contact using the stored country/region code when the determined location does not correspond to the home location.

9. The method of claim 8, wherein determining whether a location of the device corresponds to a home location comprises:
determining whether the device is roaming.

10. The method of claim 8, wherein determining whether a location of the device corresponds to a home location comprises:
identifying a network operator communicating with the device;
determining a geographic location associated with the network operator; and
determining whether the identified geographic location corresponds to the home location.

11. The method of claim 8, wherein determining whether a location of the device corresponds to a home location comprises:
identifying a geographic location associated with the device; and
determining whether the identified geographic location corresponds to the home location.

12. A mobile terminal, comprising:
a receiver configured to receive a communication having an international format telephone number associated therewith;
a memory for storing an address book for storing a number of contacts having telephone numbers associated therewith;
logic configured to:
determine whether at least a portion of the international format telephone number matches a telephone number associated with the address book contact;
store and associate the international format telephone number with the address book contact when at least a portion of the international format telephone number matches the telephone number associated with the address book contact; and
receive a user request to transmit a communication to the address book contact; and
a transmitter configured to transmit the communication to the address book contact based on the stored international format telephone number.

13. The mobile terminal of claim 12, wherein the communication comprises a telephone call request or a message.

14. The mobile terminal of claim 12,
wherein the international format telephone number includes a country or region code associated therewith, and
wherein the telephone number associated with an address book contact does not include the country or region code associated with the international format telephone number.

15. The mobile terminal of claim 12, wherein the logic is further configured to:
determine whether a geographic location of the mobile terminal corresponds to a home location associated with the mobile terminal,
wherein the transmitter is configured to transmit the communication to the address book contact based on the stored international format telephone number when the geographic location of the mobile terminal does not correspond to the home location associated with the mobile terminal.

16. The mobile terminal of claim 15, wherein the logic configured to determine whether a geographic location of the mobile terminal corresponds to a home location associated with the mobile terminal, is further configured to:
identify a network operator communicating with the mobile terminal; and
determine whether the identified network operator is associated with the home location.

17. The mobile terminal of claim 12, wherein the logic configured to store the international format telephone number with the address book contact, is further configured to:
store the international format telephone number in a hidden entry corresponding to the address book contact.

18. A computer-readable medium having stored thereon a plurality of sequences of instructions which, when executed by at least one processor, cause the at least one processor to:
receive a telephone call or message having an international format telephone number associated therewith;
determine whether at least a portion of the international format telephone number matches a telephone number associated with an address book contact;
store the international format telephone number with the address book contact when at least a portion of the international format telephone number matches the telephone number associated with the address book contact;
receive a user request to transmit a communication to the address book contact; and
transmit the communication to the address book contact based on the stored international format telephone number.

19. The computer-readable medium of claim 18,
wherein the international format telephone number includes a country or region code associated therewith, and
wherein the telephone number associated with the address book contact does not include the country or region code associated with the international format telephone number.

20. The computer-readable medium of claim 18, wherein the instructions cause the at least one processor to:
determine whether a geographic location associated with the computer-readable medium corresponds to a home location associated with the computer-readable medium; and
transmit the communication to the address book contact based on the stored international format telephone number when the geographic location associated with the computer-readable medium does not correspond to the home location associated with the computer-readable medium.
